(19) United States
(12) Patent Application Publication
(10) Pub. No.: US 2026/0244952 A1
(43) Pub. Date: Aug. 20, 2026

(54) System and Method for AI-Augmented Cognitive Refinement and Adaptive Interaction

(71) Applicant: Keith Alexander, OWENS CROSS ROADS, AL (US)

(72) Inventor: Keith Alexander, OWENS CROSS ROADS, AL (US)

(21) Appl. No.: 19/056,425

(22) Filed: Feb. 18, 2025

(51) Int. Cl. G06N 5/04; G06F 40/30; G06N 5/025

(52) U.S. Cl. CPC G06N 5/04; G06F 40/30; G06N 5/025

(57) ABSTRACT

A system and method for cognitive refinement using a two-component artificial intelligence architecture are disclosed. The system comprises a Cognitive Logic Unit (CLU) and a Persistent Context Model (PCM) connected through a bidirectional interface. The CLU retrieves contextual information from the PCM, applies structured reasoning through a rule layer and a reasoning layer, generates an output, and produces updated contextual information. The PCM stores long-term and short-term context using structured data formats and includes a relevance-filtering component configured to determine whether updated information is preserved in long-term storage. The architecture reduces redundant computation, improves reasoning stability, and enables deterministic refinement cycles through explicit communication between the CLU and PCM. The method includes receiving an input, retrieving context, generating an output using structured reasoning, updating the PCM, and storing refined context for future reasoning cycles.

### 1.1 CROSS-REFERENCE TO RELATED APPLICATIONS

None.

### 1.2 FIELD OF THE INVENTION

This invention relates to artificial intelligence systems, specifically to architectures enabling persistent, stable, and adaptive behavior through coordination between a structured reasoning module and a persistent context model implemented on computing hardware.

### 1.3 BACKGROUND OF THE INVENTION

Conventional AI systems treat each interaction as independent and lack persistent architectural structures for maintaining context. As a result, system outputs exhibit instability, inconsistent reasoning patterns, and elevated computational overhead due to repeated reprocessing of prior inputs. Existing memory-augmented approaches rely on unstructured vector retrieval systems that do not guarantee determinism, reliability, or interpretability. Traditional rule-based systems provide stability but lack adaptability and contextual continuity.

There is a need for an architecture that integrates:
persistent contextual storage,
structured reasoning mechanisms, and
a deterministic refinement loop enabling long-term behavioral consistency.

Existing systems do not provide a coordinated mechanism that binds memory persistence, relevance filtering, and structured reasoning into a unified architecture with explicit data pathways.

### Technical Problem and Improvement

The present invention provides a concrete technical improvement by introducing a two-component architecture that reduces redundant computation, stabilizes system output patterns, and improves processing efficiency through structured allocation of long-term and short-term memory. By enforcing explicit pathways between the CLU and PCM, the system reduces unnecessary reasoning cycles, improves deterministic behavior, and enables consistent operation across multiple interactions. This constitutes a specific improvement to the functioning of the computer itself.

### 1.4 SUMMARY OF THE INVENTION

The invention provides a system comprising a Cognitive Logic Unit (CLU) and a Persistent Context Model (PCM) connected by a bidirectional communication interface. The CLU performs structured reasoning using a rule layer and a reasoning layer, while the PCM stores contextual information in long-term and short-term formats using relevance scoring for selective retention.

During operation, the CLU retrieves context from the PCM, generates an output through deterministic multi-step reasoning, and produces updated contextual information. The PCM evaluates this information using a relevance-filtering component and stores it in long-term or short-term memory based on priority.

This refinement cycle enables stable, memory-informed reasoning behavior, reduces redundant computation, and provides predictable system performance across interactions.

### 2. BRIEF DESCRIPTION OF THE DRAWINGS

### Figure List

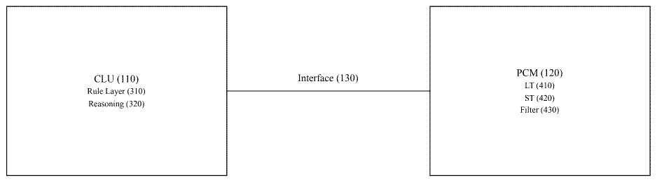

FIG. 1: System architecture showing CLU, PCM, and bidirectional interface.

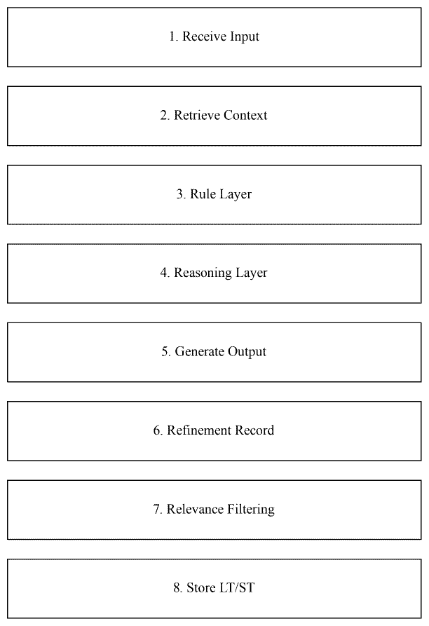

FIG. 2: Process flow of the cognitive refinement method.

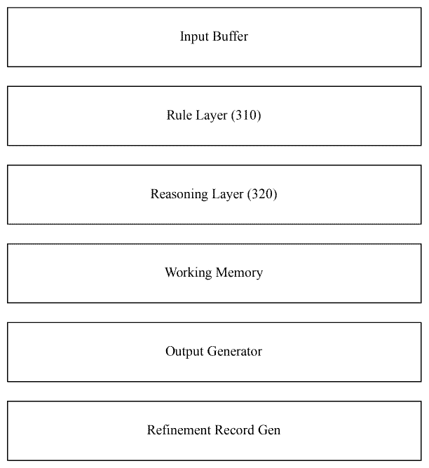

FIG. 3: Internal structure of the CLU including rule layer and reasoning layer.

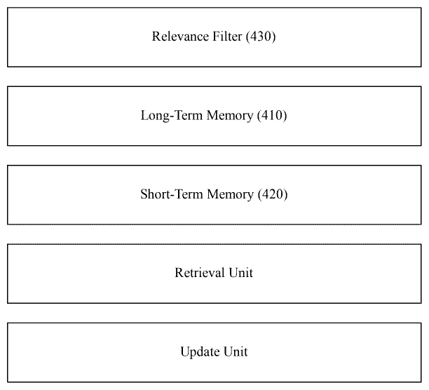

FIG. 4: Internal structure of the PCM including context storage and relevance filtering.

### Figure Descriptions

FIG. 1: Illustrates a system (100) comprising a Cognitive Logic Unit (110) and a Persistent Context Model (120) connected by a bidirectional interface (130).
FIG. 2: Illustrates a method (200) including input, context retrieval, reasoning, PCM update, and storage.
FIG. 3: Illustrates the CLU internal structure including rule layer (310) and reasoning layer (320).
FIG. 4: Illustrates the PCM internal structure including long-term storage (410), short-term storage (420), and relevance-filtering component (430).

### 3. DETAILED DESCRIPTION OF THE INVENTION

### 3.1 IMPLEMENTATION ENVIRONMENT

The system may be implemented on one or more computing devices comprising at least one processor, memory, and non-transitory computer-readable storage. The CLU and PCM are stored as executable instructions in memory and executed by the processor. Data transferred between the CLU and PCM may travel over an internal system bus, shared memory channel, network interface, or dedicated communication line.

### 3.2 SYSTEM OVERVIEW

The system comprises:
A Cognitive Logic Unit (CLU).
A Persistent Context Model (PCM).
A bidirectional communication interface connecting the CLU and PCM.

The interface supports retrieval of contextual information and storage of updated context.

### 3.3 COGNITIVE LOGIC UNIT (CLU)

### 3.3.1 Rule Layer

The rule layer enforces deterministic logic constraints including:
formatting rules,
safety boundaries,
domain-specific restrictions,
structural requirements for reasoning outputs.

### 3.3.2 Reasoning Layer

The reasoning layer performs analytical operations such as:
multi-step reasoning,
constraint-based evaluation,
inference generation,
score-based decision making.

### 3.3.3 CLU Operational Sequence

During execution, the CLU:
1. receives data blocks retrieved from the PCM.
2. loads the data blocks into a working memory buffer.
3. applies deterministic rule evaluation.
4. generates intermediate representations.
5. produces an output sequence or decision score.
6. generates a refinement record for PCM storage.

### 3.4 PERSISTENT CONTEXT MODEL (PCM)

### 3.4.1 Context Categories

The PCM stores:
long-term context,
short-term context,
task-specific or ephemeral context.

### 3.4.2 Relevance Filtering

The relevance-filtering component:
1. assigns a priority score to new contextual records based on recency, frequency, and contextual weight.
2. stores high-priority records in long-term memory.
3. stores lower-priority records in short-term memory or discards them.

### 3.4.3 PCM Update Mechanism

After each CLU reasoning cycle, the PCM receives a refinement record, evaluates it, and incorporates it into the appropriate storage category.

### 3.5 METHOD OF OPERATION

1. Receive an input.
2. Retrieve contextual data from the PCM.
3. Execute structured reasoning in the CLU.
4. Generate an output.
5. Generate updated contextual information.
6. Filter updated information using the relevance-filtering component.
7. Store updated context in long-term or short-term memory.
8. Repeat the cycle for subsequent inputs.

### 3.6 ADVANTAGES

The invention provides:
persistent memory retention,
structured and deterministic reasoning,
reduced redundant computation,
predictable behavior across interactions,
improved system performance.

1. A computer system comprising:
a processor.
memory storing instructions that, when executed by the processor, implement:
a) a Cognitive Logic Unit (CLU) comprising a rule layer and a reasoning layer configured to perform deterministic and multi-step reasoning.
b) a Persistent Context Model (PCM) comprising long-term storage, short-term storage, and a relevance-filtering component; and
c) a bidirectional communication interface enabling the CLU to retrieve contextual data from the PCM and transmit updated contextual information to the PCM.
wherein the relevance-filtering component assigns a priority score to updated contextual information and stores the updated information in long-term or short-term storage based on the score.

2. A computer-implemented method for cognitive refinement executed on one or more processors and stored on a non-transitory computer-readable medium, the method comprising:
receiving, by a processor, an input.
retrieving, from a persistent context model stored in memory, contextual data including long-term and short-term records.
executing, by a cognitive logic unit stored in memory, a rule layer and a reasoning layer to generate an output based on the input and contextual data.
generating updated contextual information during the reasoning process.
transmitting the updated contextual information to the persistent context model; and
storing the updated contextual information in long-term or short-term memory using a relevance-filtering component.

3. The system of claim 1 wherein the rule layer enforces logic, formatting, or safety constraints.

4. The system of claim 1 wherein the reasoning layer performs multi-step inferential reasoning.

5. The system of claim 1 wherein the PCM iteratively refines context across multiple interactions.

6. The system of claim 1 wherein the bidirectional interface is the exclusive communication pathway between CLU and PCM.

7. The method of claim 2 further comprising filtering contextual data prior to storage.

8. The method of claim 2 wherein retrieval includes long-term and short-term memory blocks.

9. The method of claim 2 wherein updated context influences subsequent reasoning cycles.

10. The system of claim 1 wherein priority scoring determines permanent retention.
